(19) United States
(12) Patent Application Publication
(10) Pub. No.: US 2011/0313861 A1
(43) Pub. Date: Dec. 22, 2011

(54) MOBILE ADVERTISING RELAY SYSTEM (MARS)

(75) Inventors: James R. Lawrence, III, Brooklyn, NY (US); James Hill, Fishers, IN (US); Maurice Brown, New York, NY (US)

(73) Assignee: Sprezzat! Inc., Brooklyn, NY (US)

(21) Appl. No.: 13/165,079

(22) Filed: Jun. 21, 2011

Related U.S. Application Data
(60) Provisional application No. 61/357,271, filed on Jun. 22, 2010.

(51) Int. Cl. G06Q 30/00; G06F 15/16

(52) U.S. Cl. 705/14.64; 709/201; 705/14.66

(57) ABSTRACT

A mobile advertising relay system and related methods for relaying images between a designated server and one or more mobile communication devices. The system includes at least one designated server that is configured to supply images, and a database adapted to record information relating to images, users, image publishers (e.g., advertisers), and interactions therebetween. An image queue is uniquely associated with each mobile device whereby a plurality of images are stored for future presentation to the mobile device user. In embodiments, the image queue is stored in the mobile device to facilitate rapid display of the image upon receipt of an incoming communication. The designated server includes an image selection unit for replenishing images queues, and a user profile unit for recording user preferences and image interactions. Images may be rated by the user to enable future images to be selected in accordance with the user's tastes.

### CROSS REFERENCE TO RELATED APPLICATION

This application claims the benefit of and priority to U.S. Provisional Application Ser. No. 61/357,271 entitled “MOBILE ADVERTISING RELAY SYSTEM (MARS)” filed Jun. 22, 2010, the entirety of which is hereby incorporated by reference herein for all purposes.

### BACKGROUND

The present disclosure is directed to an advertising system suitable for use with handheld communications devices, and more particularly, to a system and related methods for relaying advertising images between a designated server and a mobile device.

The mobile telecommunications industry has experienced phenomenal growth in recent years. It is estimated that there are now over 4 billion cellular telephone subscribers worldwide. Modern cellular telephones can accomplish much more than merely making telephone calls. Advances in technology have enabled the integration of previously-discrete functions into a single, economically viable handheld communication device. For example, in addition to being able to make and received telephone calls, it is common for a cellular device to include the ability to send and received instant text and multimedia messages, use internet email, browse the web, record and play back audio, photographs, and video, and to run application programs of all kinds, such as games, navigation, bookreading, and social networking.

The sheer number of cellular device subscribers represents a substantial marketing opportunity. However, targeting consumers via mobile device has proved challenging. Various attempts to advertise and/or market via cellular telephone have yielded less-than-satisfactory results and have tended to repel and annoy consumers. For example, unsolicited telephone calls, which are generally unwelcome on the home landline are doubly unwelcome on a cell phone. This is true for several reasons, including the fact that an unsolicited call may come in when a person is driving, which may be distracting and possibly a safety hazard. Another reason unsolicited cellular calls are ineffective is that they are seen as a waste of a subscriber's airtime minutes. For similar reasons, unsolicited text (SMS) messages are also viewed with distain by consumers.

### SUMMARY

The present disclosure is directed to apparatus, systems, and methods for presenting images on a user device, such as a mobile communication device, cellular telephone, smart phone, tablet device, and the like. An image may be provided from an image queue associated with the user and/or the user device. Additionally or alternatively, an image may be provided, directly or indirectly, by the calling device, termed a “peer-to-peer” image. The method includes the steps of detecting an incoming communication at a user device, determining whether a peer-to-peer image is associated with the incoming communication, displaying the peer-to-peer image on a user interface of the user device in response to a determination that a peer-to-peer image is associated with the incoming communication, displaying a queued image on a user interface of the user device in response to a determination that a peer-to-peer image is not associated with the incoming communication, and acknowledging the incoming communication by rating the displayed image. The method may include determining whether the user device is configured to receive a peer-to-peer image. The image rating (e.g., “thumbs up” or “thumbs down”) may be stored on a designated sever in a profile storage unit. Additionally or alternatively, an image and/or an image rating may be stored in the user device. The method may additionally include the steps of obtaining a replenishment image and inserting the replenishment image into the image queue associated with the user device. The replenishment image may be obtained from an image selection unit. Also disclosed is non-transitory computer-readable media comprising a set of executable instructions for performing the aforesaid method.

Also disclosed is a mobile advertising server comprising a processor, a user profile unit operably coupled to the processor comprising at least one user profile, wherein the user profile includes an image queue and a profile storage unit. The a mobile advertising server further comprises an image selection unit operably coupled to the processor and which comprising an image selector operably coupled to an image database having one or more images stored therein. The image selector may be configured to select an image stored the image database in accordance with the user profile unit. The image selector may be configured to transmit a selected image to a user device. The user profile unit may be configured to receive an image rating from a user device. The user profile unit may be configured to store a received image rating in a corresponding user profile.

The profile storage unit may be configured to store information selected from the group consisting of user identification information, device identification information, location information, authentication information, content mixer information, image history, user preference information, a user name, a first name, a surname, a street address, an email address, a telephone number, a Media Access Control address, an electronic serial number, an International Mobile Equipment Identity code, a wireless carrier identifier, a country code, a device memory indicator, a device total memory capacity, and a device free memory capacity.

In another aspect, a mobile advertising relay system is provided, comprising a user device configured for wireless communication and having the capability to receive and display images, an image queue having an entrance and an exit and adapted to store at least one image, wherein the user device is configured to display the image at the exit of the image queue upon detection of an incoming communication, a designated server configured to deliver one or more images to the entrance of the image queue in accordance with a user profile, and a database storing a user profile corresponding to the mobile device. The user device may be configured to display an image received from the initiator of the incoming communication. The user device may be configured to receive a rating associated with a displayed image. The rating may be stored in at least one of the user device or the designated server. The displayed image may include a hypertext link or other suitable user interface element activatable to display a subsequent image, to transmit information relating to the displayed image to a social network, to activate an associated application stored on the device, and/or to display to an image or content stored in the association application.

### BRIEF DESCRIPTION OF THE DRAWINGS

Various embodiments of the disclosed system and method are described herein with reference to the drawings wherein:

FIG. 1 is a schematic diagram of an embodiment of a mobile advertising relay system in accordance with the present disclosure;

FIG. 2 is a block diagram of an embodiment of a mobile device in accordance with the present disclosure;

FIG. 3 is a block diagram of an embodiment of a designated server in accordance with the present disclosure;

FIG. 4 is a flowchart of an embodiment of a method of displaying an image on a device in accordance with the present disclosure;

FIG. 5A is a view of an embodiment of a user interface delivering a general impression in accordance with the present disclosure;

FIG. 5B is a view of an embodiment of a user interface delivering an impression having an offer associated therewith in accordance with the present disclosure;

FIG. 6 is a view of an embodiment of a user interface delivering an impression having a geographic offer associated therewith in accordance with the present disclosure;

FIG. 7 is a view of an embodiment of a history-displaying user interface in accordance with the present disclosure;

FIG. 8A is a detail view of an embodiment of a user interface displaying an offer and an associated user-interaction panel displaying selection choices in accordance with the present disclosure;

FIG. 8B is a detail view of an embodiment of a user interface displaying an offer and an associated user-interaction panel displaying a selection confirmation in accordance with the present disclosure;

FIG. 8C is a detail view of an embodiment of a user interface displaying an offer and an associated user-interaction panel displaying an additional or alternative selection confirmation in accordance with the present disclosure;

FIG. 8D is a detail view of an embodiment of a user interface displaying an offer and an associated user-interaction panel displaying a another confirmation in accordance with the present disclosure;

FIG. 8E is a detail view of an embodiment of a user interface displaying a detailed offer and an associated user-interaction elements in accordance with the present disclosure;

FIG. 8F is a detail view of an embodiment of a user interface displaying an offer and an associated user-interaction panel displaying yet another confirmation in accordance with the present disclosure; and

FIG. 8G is a detail view of an embodiment of a user interface displaying an offer and an associated social networking interface.

### DETAILED DESCRIPTION

The present disclosure is directed to a mobile advertising relay system (MARS) and related methods for relaying images between a designated server, and a mobile device. An image may include, but is not limited to, an advertisement, a photograph, a video, social networking website content, multimedia content, and the like. A mobile device may encompass any suitable mobile communication device, including without limitation, a cellular telephone, a smart phone (e.g., Apple iPhone™, Research in Motion Blackberry™, and Android™-based phones), a tablet device (e.g., Apple iPad™), a navigation device, and the like. The disclosed system includes at least one designated server that is configured to supply images, and a database adapted to record information relating to images, users, image publishers (e.g., advertisers), and interactions therebetween.

The present invention may be described herein in terms of functional block components, code listings, optional selections, page displays, and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, Python, PHP, or the like, with the various algorithms being implemented with any combination of data structures, objects, processes, routines or other programming elements. The object code created may be executed by any device having a data connection capable of connecting to the Internet, on a variety of operating systems including without limitation Apple MacOS™, Apple iOS™ (f/k/a iPhone OS™), Google Android™, HP WebOS™, Linux, Microsoft Windows™, Microsoft WindowsMobile™, UNIX™, and/or Linux.

It should be appreciated that the particular implementations described herein are illustrative of the invention and its best mode and are not intended to otherwise limit the scope of the present invention in any way. Examples are presented herein which may include sample data items which are intended as examples and are not to be construed as limiting. Indeed, for the sake of brevity, conventional data networking, application development and other functional aspects of the systems (and components of the individual operating components of the systems) may not be described in detail herein. It should be noted that many alternative or additional functional relationships or physical or virtual connections may be present in a practical electronic data communications system. In the discussion contained herein, the terms user interface element and/or button are understood to be non-limiting, and include other user interface elements such as, without limitation, a hyperlink, clickable image, and the like.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., flash memory, USB thumb drives) and/or the like.

Computer program instructions embodying the disclosed invention may also be stored in a computer-readable memory that can direct a computer or other programmable data processing apparatus to function in a particular manner, such that the instructions stored in the computer-readable memory produce an article of manufacture, including instruction means, that implement the function specified in the description or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like The steps recited herein may be executed in any order and are not limited to the order presented.

The disclosed systems and/or methods may be embodied, at least in part, in application software that may be downloaded from either a website or an “app store” to the mobile device. In another embodiment, the disclosed system and method may be included in the mobile device firmware, hardware, and/or software.

In yet other embodiment, all or part of the disclosed systems and/or methods may be provided as one or more callable modules, an application programming interface (e.g., an API), a source library, an object library, a plug-in or snap-in, a dynamic link library (e.g., DLL), or any software architecture capable of providing the functionality disclosed herein. A device embodying any of the elements disclosed herein is said to be a “MARS-enabled” device.

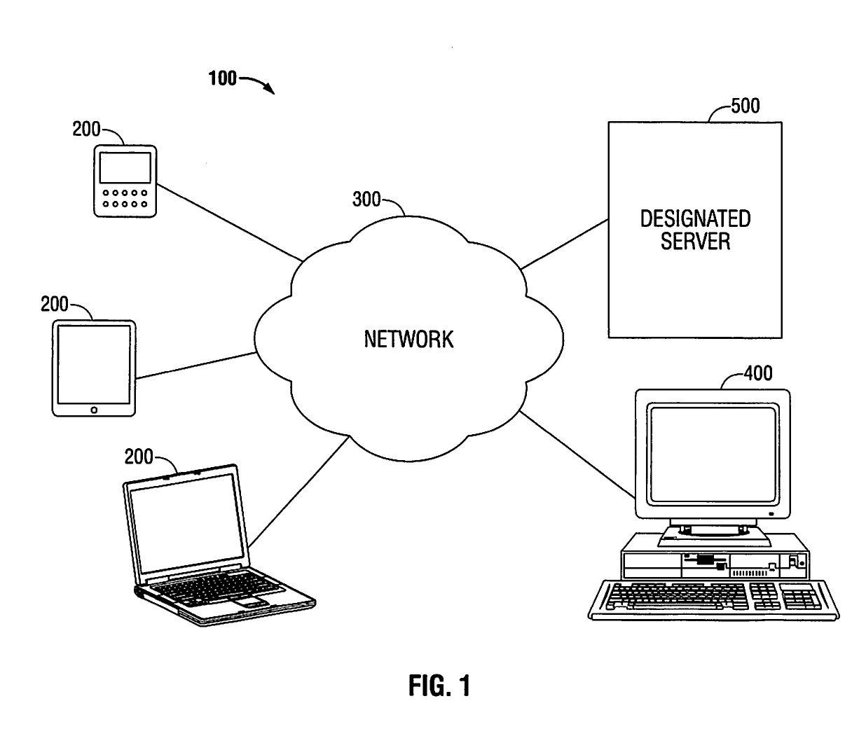

With reference to FIG. 1, an embodiment of a mobile advertising system 100 is presented. The system 100 includes a designated server 500 that is in operable communication with a data network 300. Data network 300 may encompass any suitable data network, such as, without limitation, a wireless (e.g., cellular or “WiFi”) communication network supporting any suitable data transmission protocol including without limitation CDMA, TDMA, GSM, TCP/IP, 802.11 WiFi, and the like. One or more user devices 200 are operably coupled to the data network 300. User devices 200 may include any suitable mobile device adapted for mobile communication as described hereinabove. The disclosed system 100 may include an advertiser device 400 that may include without limitation a workstation, personal computer, notebook computer, tablet computer, and so forth. Advertiser device 400 is in operable communication with data network 100 and may include executable software adapted to communicate with designated server 500 and/or or one or more user devices 200. In some embodiments, advertiser device 400 is configured to manage images, associated metadata, and other data stored within designated server 200. For example, an advertiser may add, change, view, or delete content information, demographic information, statistical information, and the like.

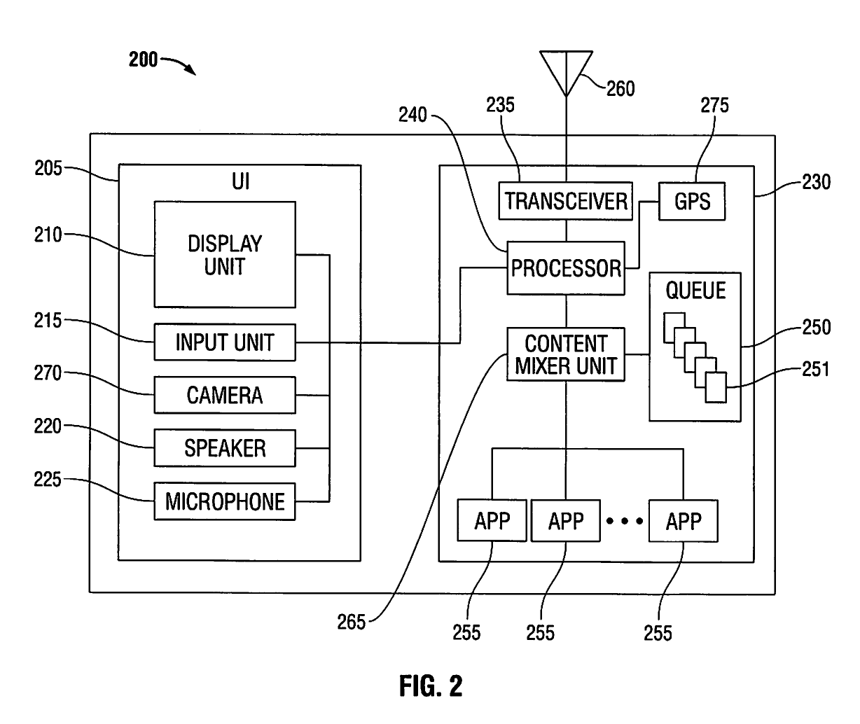

Turning to FIG. 2, a block diagram of an embodiment of a user device 200 in accordance with the present disclosure is presented. User device 200 includes a user interface unit 205 that is configured to enable interaction between user device 200 and a user, and an operational unit 230 that is in operable communication with user interface unit 205. User interface unit 205 includes at least one display unit 210 that is adapted to convey visual information to a user, and may include without limitation an LCD screen capable of displaying monochrome and/or color images, text, photographs, icons, video, and so forth as will be familiar to the skilled artisan.

User interface unit 205 includes an input unit 215 that is configured to sense inputs received from a user, such as without limitation, finger touches, finger gestures, and/or motion gestures. In an embodiment, input unit 215 may include one or more pushbuttons, a touchscreen, an accelerometer, a gyroscope, and/or combinations thereof. User interface unit 205 includes one or more speakers 220 configured to provide audio signals to a user, and one or more microphones configured to capture speech and/or other audio signals. User interface unit 205 includes at least one camera 270 that facilitates the capture of photographic (still) and video (moving) images.

Operational unit 230 includes a transceiver 235 adapted to facilitate data communications between user device 200 and data network 300. Transceiver 235 may include radiofrequency modulating and demodulating units (not explicitly shown) adapted to encode and decode, respectively, data communications. In the embodiment illustrated in FIG. 2, transceiver 235 is operably coupled to an antenna 260 which, in turn, facilitates communication among and between user device 200, data network 300, and/or designated server 500. Operational unit 230 further includes a processor 240 that is operably coupled to transceiver 235, a content mixer unit 265, a user device content queue 250, and one or more applications 255.

User device content queue 250 is configured to store one or more user device advertising images 251. In an embodiment, user device content queue 250 is configured as a first-in, first-out (FIFO) queue. One or more advertising images that may be received by user device 200 are stored in user device content queue 250 using the FIFO organization. User device content queue 250 may include storage media, including without limitation semiconductor memory, magnetic memory, organic memory, optical memory, and/or any suitable storage media now or in the future known. User device content queue 250 may optionally include data stored in association with a user device advertising image 251. Such associated data may include an advertiser identifier, a timestamp, a rating, an enumeration, an ordering, a market identifier, and/or a product identifier.

In one embodiment, one or more user device advertising images 251 are initially placed in user device content queue 250 of an individual user device 200 for presentation to a user of said user device 200. A presentation of an image 251 to a user is referred to as an “impression.” The number and type of images initially loaded into the user device content queue 250 may depend, at least in part, upon the resources (e.g., storage, memory, processor speed, etc.) available in the target user device 200. Additionally or alternatively, a content queue may be maintained within designated server 500 as described hereinbelow, in a storage array (not explicitly shown), in a distributed storage architecture (e.g., in a “cloud”), or in any suitable storage architecture now or in the future known. If user device content queue 250 is organized as a first-in/first-out (FIFO) queue, then images are displayed in a FIFO order. In some embodiments, other queue structures may additionally or alternatively be employed. For example, device content queue 250 may be organized as a last-in/first-out queue (LIFO or stack), or a circular (ring) queue.

When an incoming communication is detected by the mobile device 200, such as without limitation, an incoming voice call, a subsequent incoming voice call (e.g., a “call waiting” event), a text (SMS) message, and/or a multimedia message (MMS), the next image 251 is popped from the user device content queue 250 and presented to the user on display unit 210. A banner may additionally be presented that displays information relating to the identity of the caller. In an embodiment, the image 251 is displayed utilizing the entire expanse of display unit 210, e.g., a “fullscreen” display. Alternatively, the image 251 may be scaled to utilize less than the entire expanse of display unit 210.

In embodiments, the image display order may be changed or reprioritized in accordance with one or more prioritization parameters. A prioritization parameter may be set by a content mixer unit 265 that is configured to enable a user to input a user preference relating to image content, image type, image source, and so forth. For example, and without limitation, assume a user is a zealous football fan, is moderately interested in baseball, and planning a vacation. Using the content mixer unit 265, the user can specify that more football- and travel-related images be displayed, and less baseball-related images be displayed. The precise category of image (e.g., football-related, baseball-related, or travel-related) may be predefined by the image (or image source), and/or may be user-defined. In some embodiments, a user image categorization may be overridden by a predefined image categorization.

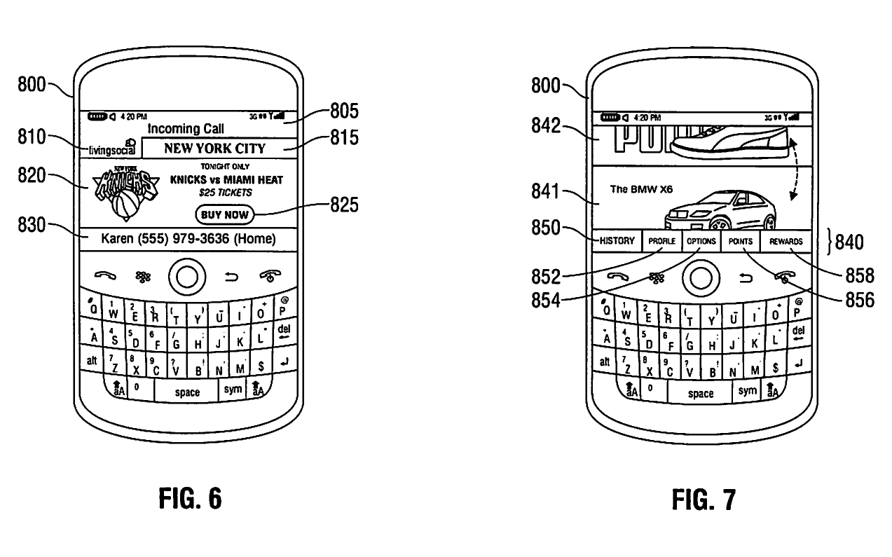

An image priority may be assigned in accordance with location data received from GPS receiver 275. In this manner, for example without limitation, an image relating to a merchant in physical proximity to the user device 200 (e.g., within a predetermined radius) may be displayed in preference to other images in the queue. For example, as shown in FIG. 6, a user device 800 is receiving an incoming call as depicted by incoming call banner 805. Caller identification information 830 is displayed. An image sponsor 810 may optionally be displayed. Location data is displayed by a location banner 815. The current image 820 is presented in association with a “buy now” button that encourages the user to purchase an item from the local merchant.

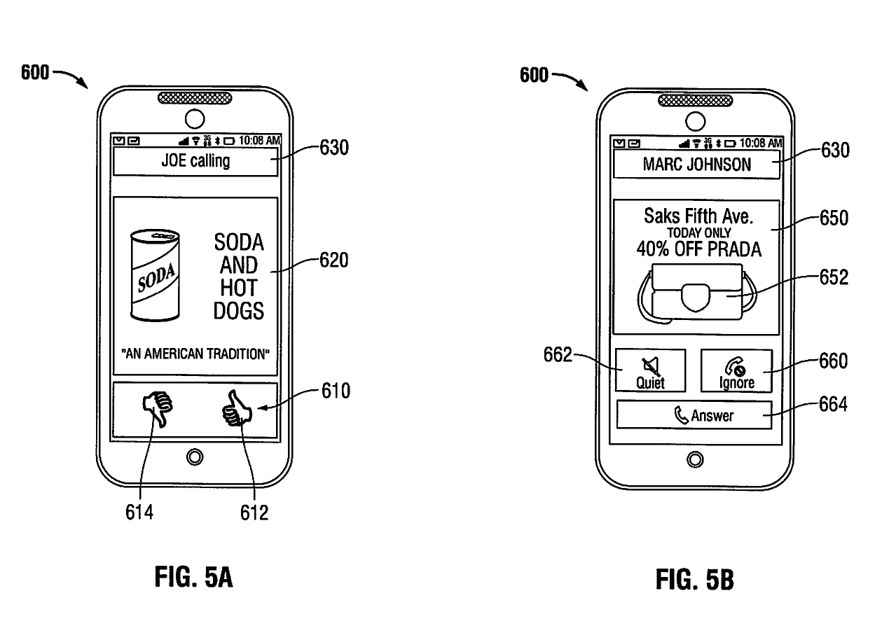

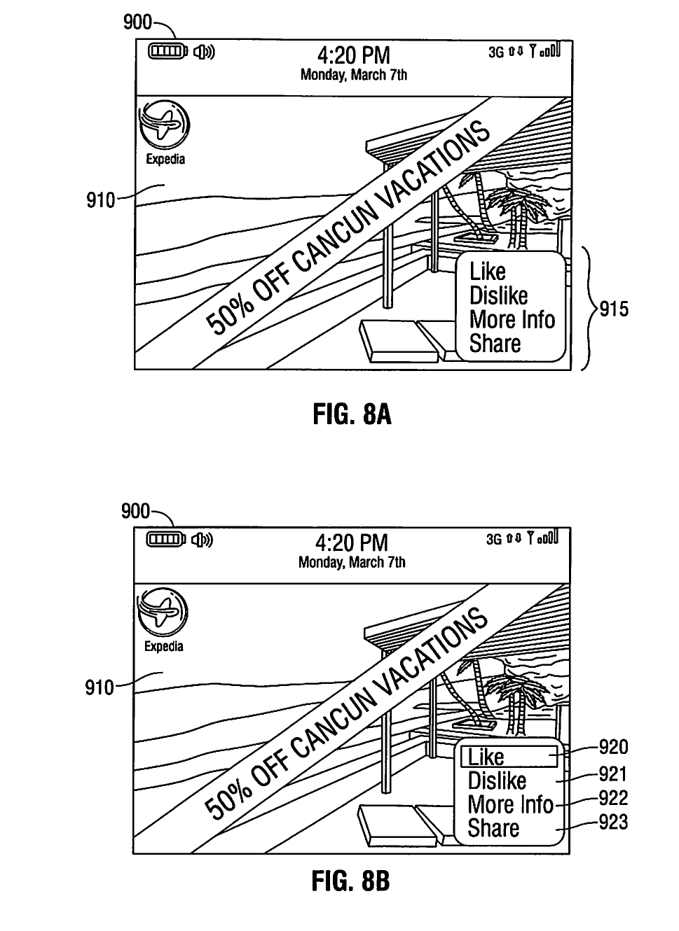

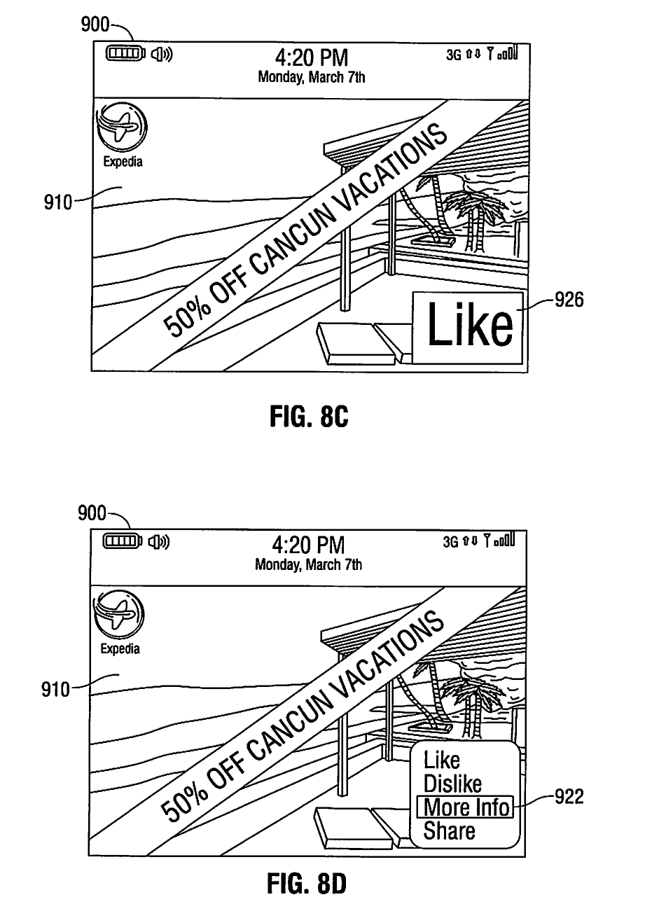

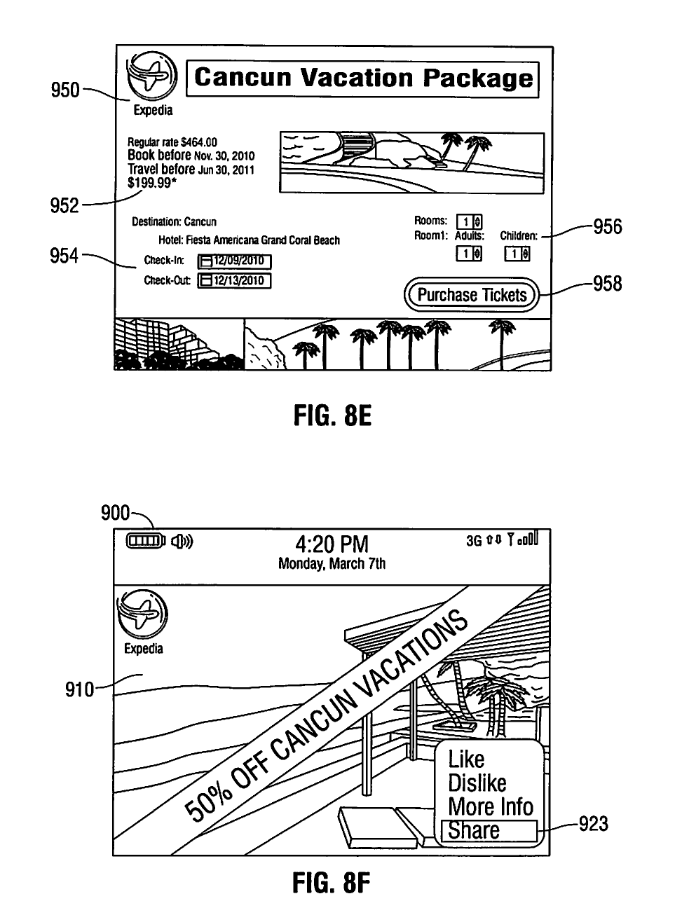

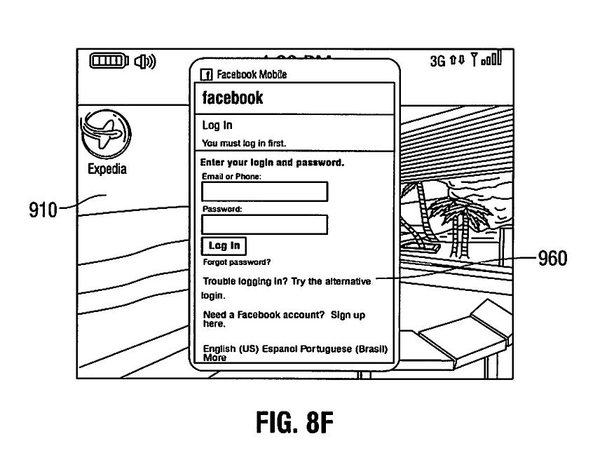

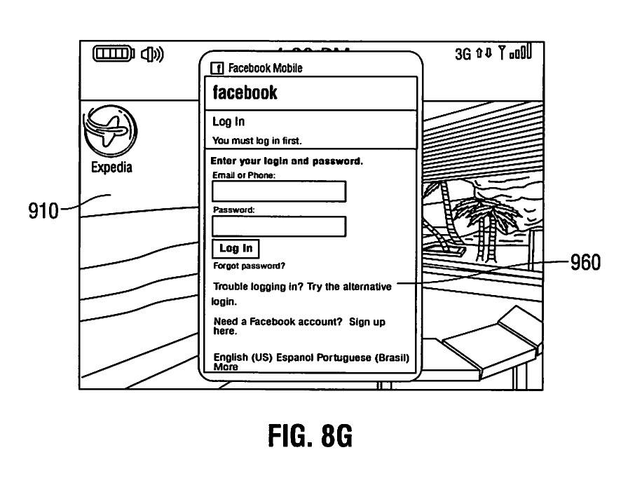

With reference to FIGS. 5A, user device 600 is shown during receipt of an incoming communication, e.g., a telephone call. In response to the displayed image 620, the mobile device user may tag the image using, e.g., a thumbs up button 612 to rate the image positively, a thumbs down key 614 to rate the image negatively. In an embodiment, tagging the image using the thumbs up button 612 or the thumbs down button 614 also answers the call. The user may also answer the call without tagging the image by activating a non-tag region 610. It should be understood that the thumbs up/down buttons may be represented by alternative means, e.g., by an up/down arrow, plus/minus sign, by differentiating colors, or by any suitable visual indicia. For example, as seen in FIG. 8a, a display 900 includes an image 910 having an option menu 915 superimposed thereupon. Option menu includes a “like” option 920, a “dislike” option 921, a “more info” option 922, and a “share” option 923. In an embodiment represented in FIGS. 8B and 8C, selection of an option, e.g., “like” option 920, is highlighted and/or confirmed by a visual confirmation 926. In an embodiment shown in FIGS. 8D and 8E, a user may select the “more info” 922 option which, in turn, causes to be presented a subsequent image 950 including more detailed information relating to the prior image 910. Subsequent image 950 may include additional information 952 and/or one or more selectors 954, 956 with which a user may indicate preferences relating to acceptance of the offer, e.g., dates, quantities, and the like. Subsequent image 950 may include a confirmation user interface element 958 with which a user may confirm acceptance of the offer, e.g., a “place order” button, a “buy now” button, a “purchase tickets” button, and the like.

Once the recipient answers the call, views the SMS/MMS message, or otherwise acknowledges the incoming communication, the image 620 disappears from the device screen. In another embodiment, the image 620 remains on the device 600 screen after the incoming communication is acknowledged. The image 620 may continue to be displayed for the duration of the communication (e.g., the duration of the call), or, may disappear after a period of time. The image 620 may disappear rapidly, or, may fade gradually to the device's default image or some other image. In one aspect, tagging an image 620 causes one or more search words to be stored for search associations.

As seen in FIG. 5B, an image 650 may include an activation region 652 that enables a user to accept an offer tendered therein while concurrently answering an incoming telephone call. Alternatively, a user may receive the call without accepting the offer by touching an answer button 664, reject the call by touching an ignore button 660, or silence any ringtone or vibration by touching a quiet button 662. In an embodiment, by receiving the call via touching the activation region 652, the offer may be transmitted to the user device 600 by, e.g., an email or a text message. In an embodiment, the offer may include machine-readable indicia (e.g., a barcode) to facilitate redemption by a merchant.

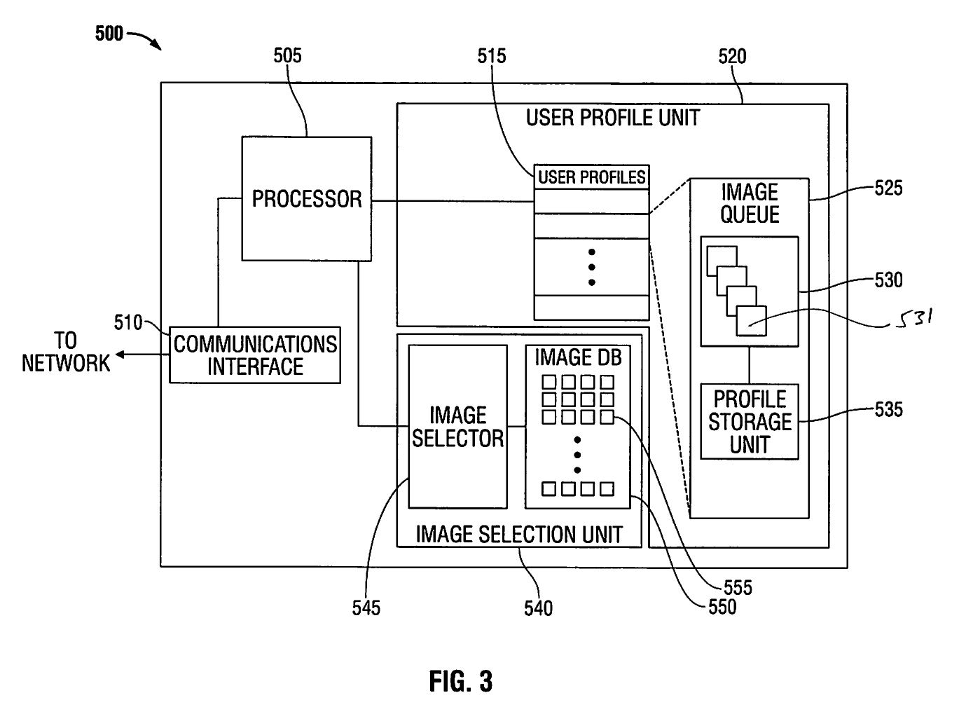

Turning to FIG. 3, a block diagram of an embodiment of a designated server 500 in accordance with the present disclosure is presented. The designated server 500 includes at least one processor 505 that is operably coupled to a communications interface 510. Communications interface 510 is configured to be operably coupled to network 300 and may support one or more communications protocols, e.g., TCP/IP. Processor 505 is operably coupled to user profile unit 520 and image selection unit 540.

A system and method in accordance with the present disclosure may include at least one database. The database is configured to store data relating to, e.g., mobile device subscribers, images transmitted to devices, images actually viewed, user preferences, tag data, and the like. In one aspect, the number of times each image is pushed to a mobile phone is tallied in the database. Because images are replaced as soon as they are displayed, and the order of images within a user's queue may be predetermined, the database can capture the number of times each image is displayed on each user's mobile device. In embodiments, the predetermined image order may be modified. For example, and without limitation, the image order may be modified by a user thumbing up or thumbing down an image, user rankings, use of the content mixer as described herein, and/or special promotions that may be available to the user. The image order may also be modified or determined to in accordance with content contained within a user's most frequently used mobile applications. In one non-limiting example, assume a user has three MARS-enabled mobile applications installed on their phone: an ESPN™ application, a CNN™ application, and a Groupon™ application. Each day, the user uses the ESPN™ application several times a day, while almost never using the other two applications. Accordingly, the system will display ESPN™ content more frequently than CNN™ or Groupon content™. In this manner, the end user's application usage trends and history may influence the mix of content displayed when their phone rings.

User profile unit 520 includes one or more user profiles 525 that uniquely correspond to an individual user. In some embodiments a user profile 525 additionally, alternatively, or optionally corresponds to a unique user device 200. The one or more user profiles 515 may be stored in a user profile database 515 or other data structure capable of facilitating random access to user profile 525 data. A user profile 525 includes a server image queue 530 that is configured to store one or more images 531 as described herein. User profile 525 additionally includes a profile storage unit 535 that is configured to store information relating to an individual user and/or device, including without limitation, user identification information, device identification information, location information, authentication information, content mixer information, image history, and/or user preference information. For example, and without limitation, profile storage unit 535 may include a name, street address, email address, telephone number, Media Access Control address (MAC address), electronic serial number, International Mobile Equipment Identity code (IMEI code), a wireless carrier identifier, a country code, and a device memory indicator (e.g., device memory capacity, device free memory, and the like).

Image selection unit 540 includes an image selector 545 and an image database 550 having one or more images 555 stored therein. The one or more images 555 may be transmitted to image database 550 from an advertiser device 400. During use, an image request may be received by image selector 545 from a user device 200. In response, image selector chooses an image 555 from within image database 550. In one embodiment, an image request is received from a user device 200. To process the image request, the image selector 545 may access a user profile 525 corresponding to the user device 200 from which the request originated and/or a user profile 525 corresponding to a user associated with the originating user device 200. For example, an image history may be consulted to ensure a duplicate or recently-seen image is not selected. In another embodiment, one or more user preferences may be consulted to determine which image is to be selected. In an embodiment, content mixer information is consulted to select a suitable image in view of a user content mixer setting. Upon selection of an image, the image selector may transmit the image to the device image queue 250 and/or to the designated server image queue 530. The image may be replicated (e.g., copied into the respective queue) or, alternatively, an image identifier (e.g., a pointer or URL) may be provided to the respective queue.

Additionally or alternatively, data relating to at least one of the following transactions may be recorded within the profile storage unit 535:

1. When a user reviews their received images and “clicks through” to view the publisher's web content for a full description of the image.

2. When the user forwards images to others, e.g., to friends on Facebook™, Myspace™, Twitter™, and the like, to an email recipient via SMS/MMS messaging. Additionally, if the recipient's mobile device is MARS-enabled, and the shared image is added to the recipient's queue, this fact is recorded in the database as well.

3. The number and/or identity of bookmarks created from selected, thumbed-up, and thumbed-down images are recorded.

4. The number and/or identity of images that the user saves to the mobile device's photo album.

5. Whether a user has enabled the location-based images option, and if so, the user's location is recorded in the database. The recorded location may be updated as the user travels about.

6. Whether a user is clicking through to a publisher's web content beyond a predetermined number of times within a predetermined timeframe. This is to detect and reduce click-through fraud.

7. An image may include a mobile coupon. Usage of mobile coupons is tracked by assigning unique promotional codes (tracking numbers) to each issued coupon. This also allows individual coupons to be deactivated (discontinued) based on the life of the associated promotion, and may create a sense of urgency to spur usage.

8. User profiles that capture and/or characterize the overall activity of each user.

The aforesaid transactions 1-8 may cause adjustment(s) to the corresponding user's profile on the server, which, in turn, may influence (e.g., increase or decrease) the rate of distribution of related images. In yet another aspect, the database and/or the designated server may be configured to provide detailed reporting on all user activity metrics. Advantageously, reports may be generated that are specific to individual publishers (e.g., advertisers.) For example, for each publisher, the database has the capability to create a customizable batch report containing data including but not limited to tagged images, click-through, shared images, bookmarks, photo album, and user profiles. A user profile may include, without limitation, at least one of a user's name, street address, email address, phone number, or image thumbs-up/thumbs-down history.

Thus when a communication is terminated, the user device 200 contacts the designated server 500, whereupon a new image based on the user's profile (e.g., user defined interests, brands, content, thumbs up/down history, etc.) is selected by the image selection unit 540, transmitted to the user device via network 300, and placed into the user device queue 250 and/or the designated server queue corresponding to the requesting user device 200. In accordance with a FIFO queuing model, the new image goes to the entrance of the queue, and leaves via the exit of the queue.

In an embodiment, the queued images will take precedence (e.g., override) any photos saved in the mobile device's address book from being displayed when an incoming communication is detected.

One or more images are stored in the mobile device's queue 250. If the device's data connection is interrupted, images 251 will continue to be displayed when incoming communications are detected, e.g., voice calls, texts, etc. Once the mobile device's data connection is reconnected to the network, the device will notify the designated server 500 of the number of images in the queue that were displayed while offline. In response, the designated server 500 delivers to the device's queue an equal number of new images, replenishing the device queue 250 and/or server queue 530.

In another embodiment, a peer-to-peer image impression may be performed. When a calling user initiates an outgoing communication on the mobile device, e.g., places an outgoing voice call, an image that matches the calling user's interests and/or profile is displayed on a recipient user's mobile device. When peer-to-peer functionality is enabled on the recipient's device, the image transmitted from originating device will trump (e.g., supersede or pre-empt) the images in queue 250 on the recipient device. The recipient of the call can either tag the image with, e.g., thumbs up/down hot key and answer the call, or answer the call without tagging the image. When the recipient acknowledges the incoming communication (e.g., answers the call), the image disappears from the screen of the mobile device. In another embodiment, the image remains on the device screen after the communication is acknowledged. The image may continue to be displayed for the duration of the call, or, may disappear after a period of time. The image may disappear rapidly, or, may fade gradually to the device's default image or some other image. In an embodiment, the described peer-to-peer feature is selectively enabled by the user, as desired.

After the communication concludes (e.g., the call is terminated), the calling mobile device 200 and/or the recipient mobile device 200 contacts the designated server 500. The designated server 500 transmits a new image to the calling mobile device 200 that is placed at the entrance of the calling device's queue 250. The designated server additionally or alternatively records the impression (e.g., records the fact that the image was displayed to the recipient). When a peer-to-peer image is sent to a recipient, a new image need not be sent to the recipient's mobile device 200 from the designated server 500, since none of the images in the recipient's queue 250 were viewed.

Users must have peer-to-peer images enabled within their respective mobile devices 200 in order to send and/or receive peer-to-peer image impressions. In an embodiment, a recipient may control the frequency of peer-to-peer images they receive from callers using a content mixer 265, as described hereinbelow. The content mixer 265 may include an image display frequency controller that is configured to enable a user to modify parameters relating to image display of peer-to-peer images.

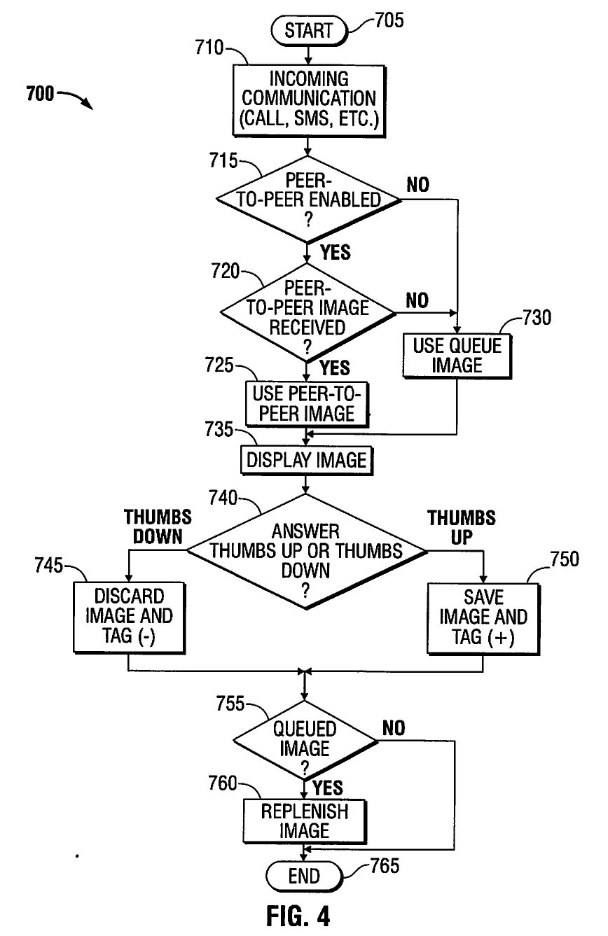

In another aspect, a method 700 for presenting images to a mobile device user is disclosed with reference to FIG. 4. The method initiates with the step 705 in which a user device (e.g., user device 200) is ready to receive an incoming communication. In the step 710 an incoming communication is detected by the user device, whereupon in the step 715 a determination is made whether the peer-to-peer option is enabled in the user device. If in the step 715 a determination is made that peer-to-peer is not enabled, processing proceeds with the step 730 as described below. If, in the alternative, a determination is made that peer-to-peer is enabled in the user device, then in the step 720 a determination is made as to whether a peer-to-peer image is available. In an embodiment, the peer-to-peer image determination may include examining data included within the incoming communication, and/or may include querying a remote server, such as designated server 500, to determine whether the calling party has associated therewith a peer-to-peer image available for viewing by the recipient party.

If, in the step 720 a determination is made that a peer-to-peer image is available, then in the step 725 the peer-to-peer image is chosen for display on a user interface for the user device. Alternatively, if no peer-to-peer image is available, then in the step 730, the next image is popped from the image queue associated with the user device and chosen for display. The image queue associated with the user device may be one included within the user device, within the designated server, shared or distributed between the user device and the designated server, and/or within one or more other servers or devices (e.g., “in the cloud”). In the step 735, the chosen image is displayed on a user interface of the user device.

In the step 740 the user acknowledges the incoming communication (e.g., answer the call) by rating the displayed image (e.g., “thumbing up” or “thumbing down” the image). If the displayed image is rated negatively (e.g., “thumbs-down”), then in the step 745 the image is not saved in the user device history and a negative rating associated with the image is stored in the profile storage unit. Alternatively, if the image is rated positively (e.g., “thumbs-up”), then in the step 750 the image is saved in the user device history and a positive rating associated with the image is stored in the profile storage unit.

In the step 755 it is determined whether the displayed image is a peer-to-peer image or a queued image. If the image is a queued image, then in the step 760 a replenishment image is obtained and inserted into the image queue associated with the user device. In an embodiment, the step 760 includes obtaining a replenishment image from the image selection unit 540. The method concludes with the step 765.

As shown in FIG. 7, a user may review image history (as shown by example as images 841, 842) that have been previously received on the mobile device 800. Additionally or alternatively, historical images may be identified, saved, and/or isolated. The user may select (e.g., tap or click) on any previously received image, which, in turn, establishes a connection to, e.g., the image publisher's website, which, in turn, may provide additional information to the user and/or to enable a user to consummate a transaction, e.g., make a purchase, reserve a table, redeem a coupon, and the like. Depending on the mobile device capabilities, this clickthrough may connect the user to a subsequent page within a MARS application, within a non-MARS (e.g., third party) application, or to the MARS API, in order to view the image publisher's web content. A “back” button may be utilized to enable a user to navigate back to the list of previously received MARS images, thereby providing a convenient way for the user to look up one or more multiple publisher's web content from their received images list without having to navigate between the MARS application and the mobile device's web browser. In an embodiment, a web browser is embedded within the MARS application. In an embodiment, a web browser is extended though an API to support one or more of the functions disclosed herein. A navigation strip 840 including one or more navigation buttons 850, 852, 854, 856, 858 may be provided to enable user access to history data, profile data, option data, points data, and rewards data, respectively.

A user may save favorite images to their mobile device's photo album, desktop wallpaper, screensaver, and the like. The user may save tagged brands, image publisher's web content, and the like, to a bookmarks or favorites repository on their mobile device's internet browser.

In yet another aspect, a user may view additional content and/or images from the queue without having to acknowledge an incoming communication (e.g., receive an incoming call) by pressing a specific “hot key” or the like. This option enables images to be displayed and/or received from the designated server, in addition or alternatively to those images being displayed as a result of an incoming communication. Images that have been viewed may be indexed under a “previously received images” user interface element, such as without limitation, a tab, provided on the mobile device's user interface.

As illustrated in FIGS. 8F and 8G, a mobile device relay system in accordance with the present disclosure may provide selective social networking functionality. For example, a user may select a “share” option 923 in response to a displayed image 910. In response, an authentication dialog box 960 may be presented to enable a user to access a social networking provider. Images so tagged may then be posted on a social networking site for sharing with the user's friends or followers on the site. In one aspect, a user may post Facebook™ and/or MySpace™ status updates, photos, and Twitter™ “tweets” via the content mixer application, as described hereinbelow. The content mixer may enable a user to increase and decrease frequency of displays, updates, and posts to one or more social networking sites. In an embodiment, a user is able to share tagged images with another mobile device directly. Social networking “friends” of the user, and whose mobile device is MARS-enabled, may then choose one or more shared images for addition into their own queue, and for further sharing, if desired.

By way of non-limiting example, assume that images A, B, and C are in queue on a user's mobile device. The user receives an incoming call and image A is displayed. When the call concludes, image A is purged from the user's mobile device. Thereafter, images B and C move up in the queue. The mobile device sends a request to the designated server to send a new (replenishment) image to the queue on the user's mobile device. In response to the request, the designated server sends image D (a new image) to the entrance of the queue on the mobile device, replenishing the queue. At this point, images B, C and D are in queue. The database records the fact that image A was displayed (since a request was received to replenish the queue), and also, records the fact that image D was added to the queue.

When a user tags an image with the thumbs up key, the designated server adjusts the user's profile, which increases the rate of distribution of images that match the characteristics of the tagged image for subsequent replenishment. Conversely, when the user tags the image with the thumb down hot key, the server adjusts the user's profile, reducing the distribution of similar images. The user's profile and adjustments thereto may be stored within the database

In still another aspect, the disclosed mobile advertising relay system includes the capability to allow users to rank or weight the images displayed on their mobile phone. This enables users to increase or decrease the frequency an image is displayed. In one aspect, a predetermined image order may be modified in this manner. By way of non-limiting example, a user downloads the NFL™ mobile app (that incorporates MARS technology) to his mobile device. The mobile device now begins to receive NFL™ images when an incoming message is detected (e.g., the phone rings or an SMS/MMS message is received. Next, the user downloads the NBA™ mobile app which also utilizes MARS technology. The content mixer allows the user to centrally control the ratio of NFL™ to NBA™ images (e.g. 80% NFL™, 20% NBA™). When additional MARS-enabled mobile applications are downloaded to the user's mobile device, the user can further refine the mix of MARS enabled images. All adjustments made with the content mixer may be recorded in the database and/or the designated server, further developing and refining user profiles.

In another embodiment, a mobile advertising relay system in accordance with the present disclosure includes a logo recognition and brand searching capability. On MARS-enabled mobile devices, users can photograph branded logos (Levi's Jeans™, Olympics™, ESPN™, etc.) thereby adding those brands to the user's profile. An image recognition module processes the image to identify the brand represented therein. The image recognition module may be included in the mobile device and/or a server. Once added, the user will begin to have images from the added brand(s) included in their queue. If the image is not found, or cannot be identified, the user is given an option to search a brand database, request the brand, or input a corresponding brand identifier. This information may be stored in the database.

In yet another embodiment, a mobile advertising relay system in accordance with the present disclosure includes a music recognition and tagging capability. On MARS-enabled mobile devices, users can sample an audio signal, e.g., music, using a built in microphone and/or audio input of the mobile device. A sound recognition module processes the sampled audio to identify the sampled sound, e.g., song name, artist name, movie title, genre, etc. The sound recognition module may be included in the mobile device and/or a server. Once added, the user will begin to have content relating to the sampled sound (artist, record label, genre) included in the queue.

In yet another embodiment, a MARS-enabled device may import or “discover” content from a user's media library. The MARS device may access a user's media library stored within user device 200, and/or may access one or more external user libraries by wired means, e.g., while docked or synching to a host computer, or wirelessly over cellular, WiFi, Bluetooth, or other wireless connections now or in the future known. For example, and without limitation, a MARS-enabled device may discover a user's music and/or iTunes™ library, optionally identify favorite tracks contained therein based upon metrics, e.g., song play frequency, which then causes to be downloaded into the queue related content, e.g., artist images, artists tweets, fan club content, direct offers, local tour date notifications, media downloads, and the like.

In another embodiment, images in a user's profile may be tagged and weighted based on the relevance thereof to the user's interests. In one aspect, the weighting determines the mix of weighted content, e.g., high value/direct match content versus lower value/related or targeted content. The resultant content mix may then be transmitted to the MARS queue of the user's mobile device.

In yet a further aspect, a mobile advertising relay system in accordance with the present disclosure includes location-based imaging capability based on, e.g., the global positioning system (GPS), assisted GPS (A-GPS), cell site triangulation, and the like. The location-based capability may be selectively enabled by a user. Once enabled, the mobile device relays its geographical location to the designated server and images are added to the queue based on the device's geographic location. A polling frequency may be specified by a user, e.g., by use of the content mixer, that determines the rate at which images may be added to the user's queue.

Particular embodiments of the present disclosure have been described herein, however, it is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

What is claimed is:

1. A method for presenting images on a user device, comprising:
detecting an incoming communication at a user device;
determining whether a peer-to-peer image is associated with the incoming communication;
displaying the peer-to-peer image on a user interface of the user device in response to a determination that a peer-to-peer image is associated with the incoming communication;
displaying a queued image on a user interface of the user device in response to a determination that a peer-to-peer image is not associated with the incoming communication; and
acknowledging the incoming communication by rating the displayed image.

2. The method in accordance with claim 1, further comprising determining whether the user device is configured to receive a peer-to-peer image.

3. The method in accordance with claim 1, further comprising receiving a peer-to-peer image.

4. The method in accordance with claim 1, further comprising storing a rating associated with the image in a profile storage unit.

5. The method in accordance with claim 1, further comprising storing the image in the user device.

6. The method in accordance with claim 1, further comprising:
obtaining a replenishment image; and
inserting the replenishment image into the image queue associated with the user device.

7. The method in accordance with claim 6, wherein the replenishment image is obtained from an image selection unit.

8. Non transitory computer-readable media comprising a set of executable instructions for performing the method of claim 1.

9. A mobile advertising server, comprising:
a processor;
a user profile unit operably coupled to the processor comprising at least one user profile, wherein the user profile includes an image queue and a profile storage unit; and
an image selection unit operably coupled to the processor comprising an image selector operably coupled to an image database having one or more images stored therein.

10. The mobile advertising server in accordance with claim 9, wherein the image selector is configured to select an image stored the image database in accordance with the user profile unit.

11. The mobile advertising server in accordance with claim 10, wherein the image selector is further configured to transmit the selected image to a user device.

12. The mobile advertising server in accordance with claim 10, wherein the user profile unit is configured to receive an image rating from a user device.

13. The mobile advertising server in accordance with claim 12, wherein the user profile unit is further configured to store a received image rating in a corresponding user profile.

14. The mobile advertising server in accordance with claim 9, wherein the profile storage unit is configured to store information selected from the group consisting of user identification information, device identification information, location information, authentication information, content mixer information, image history, user preference information, a user name, a first name, a surname, a street address, an email address, a telephone number, a Media Access Control address, an electronic serial number, an International Mobile Equipment Identity code, a wireless carrier identifier, a country code, a device memory indicator, a device total memory capacity, and a device free memory capacity.

15. A mobile advertising relay system, comprising:
a user device configured for wireless communication and having the capability to receive and display images;
an image queue having an entrance and an exit and adapted to store at least one image, wherein the user device is configured to display the image at the exit of the image queue upon detection of an incoming communication;
a designated server configured to deliver one or more images to the entrance of the image queue in accordance with a user profile; and
a database storing a user profile corresponding to the mobile device.

16. The mobile advertising relay system of claim 15, wherein the user device is further configured to display an image received from the initiator of the incoming communication.

17. The mobile advertising relay system of claim 15, wherein the user device is further configured to receive a rating associated with a displayed image.

18. The mobile advertising relay system of claim 17, wherein the rating is stored in at least one of the user device or the designated server.

19. The mobile advertising relay system of claim 15, wherein the displayed image includes a hypertext link activatable to display a subsequent image.

20. The mobile advertising relay system of claim 15, wherein the displayed image includes a hypertext link activatable to transmit information relating to the displayed image to a social network.
